(19) United States
(12) Patent Application Publication
(10) Pub. No.: US 2022/0207459 A1
(43) Pub. Date: Jun. 30, 2022

(54) INFORMATION PROCESSING DEVICE, INFORMATION PROCESSING METHOD, AND INFORMATION PROCESSING SYSTEM

(71) Applicant: KDDI CORPORATION, Tokyo (JP)

(72) Inventors: Masayuki TACHIIWA, Tokyo (JP); Tomoaki MATSUKI, Tokyo (JP); Mitsuyoshi MIYAZAWA, Tokyo (JP)

(73) Assignee: KDDI CORPORATION, Tokyo (JP)

(21) Appl. No.: 17/411,581

(22) Filed: Aug. 25, 2021

(30) Foreign Application Priority Data
Dec. 28, 2020 (JP) 2020-219092

(51) Int. Cl. G06Q 10/08; G06Q 10/06; B64C 39/02

(52) U.S. Cl. CPC G06Q 10/083; G06Q 10/06315; B64C 2201/128; G06Q 10/06313; B64C 39/024; G06Q 10/06312

(57) ABSTRACT

An information processing device includes: an information acquiring unit configured to acquire article identification information from an information terminal; a specifying unit configured to specify a total weight value of one or more delivery target articles corresponding to one or more pieces of the article identification information by referring to an article database; a determination unit configured to determine whether or not the one or more delivery target articles can be delivered by a flying object on the basis of at least the total weight value; and a display control unit configured to cause the information terminal to display a delivery method designation screen on which a delivery method for delivering articles using the flying object can be designated in a case in which the determination unit determines that the one or more delivery target articles can be delivered by the flying object.

### BACKGROUND OF THE INVENTION

### Field of the Invention

The present invention relates to an information processing device, an information processing method, and an information processing system.

Priority is claimed on Japanese Patent Application No. 2020-219092, filed Dec. 28, 2020, the content of which is incorporated herein by reference.

### Description of Related Art

In related arts, delivery systems delivering an article to a delivery destination using an unmanned flying object are known (for example, see Japanese Unexamined Patent Application, First Publication No. 2016-153337).

### SUMMARY OF THE INVENTION

For an unmanned flying object, for example, different from delivery vehicles such as a truck and the like, a delay in delivery time due to congestion of roads does not occur, and thus the unmanned flying object is useful as a delivery method for shortening a delivery time. However, for an unmanned flying object, the deliverable weight or the deliverable size is restricted, and thus, there are cases in which an article cannot be delivered depending on the weight or the size of the article. As a result, there is a problem in that it is difficult for a delivery destination user of an article to check whether or not delivery using an unmanned flying object can be used.

The present invention is in view of such points, and an object thereof is to easily check whether or not an article to be delivered can be delivered using an unmanned flying object.

According to a first aspect of the present invention, there is provided an information processing device including: an information acquiring unit configured to acquire article identification information used for identifying delivery target articles from an information terminal used by a user requesting delivery of a delivery target article that is a target to be delivered; a specifying unit configured to specify a total weight value of one or more delivery target articles corresponding to one or more pieces of the article identification information acquired by the information acquiring unit by referring to an article database including weight of each of a plurality of articles; a determination unit configured to determine whether or not the one or more delivery target articles can be delivered by a flying object on the basis of at least the total weight value; and a display control unit configured to cause the information terminal to display a delivery method designation screen on which a delivery method for delivering articles using the flying object can be designated in a case in which the determination unit determines that the one or more delivery target articles can be delivered by the flying object.

Sizes and the weights of the plurality of articles are associated with each other in the article database, the specifying unit specifies a total size value of the one or more delivery target articles, and the determination unit may determine whether or not the one or more delivery target articles can be delivered by the flying object on the basis of the total weight value and the total size value.

The information acquiring unit may further acquire use status information that represents use statuses of the plurality of flying objects, and the determination unit may determine whether or not the one or more delivery target articles can be delivered by the flying object on the basis of the use status of the flying object represented by the use status information.

Return date and time information representing a date and time at which the flying object is scheduled to return to a predetermined place may be included in the use status information, and the determination unit determines whether or not the one or more delivery target articles can be delivered by the flying object on the basis of the date and time represented by the return date and time information.

The information acquiring unit may further acquire delivery destination information including location information representing location of delivery destinations of the one or more delivery target articles, and the determination unit may determine whether or not the one or more delivery target articles can be delivered by the flying object on the basis of the location of the delivery destinations represented by the delivery destination information.

The determination unit may determine whether or not the one or more delivery target articles can be delivered by the flying object on the basis of whether or not the location of the delivery destination is included in an area, to which the one or more delivery target articles can be delivered by the flying object, that is set in advance.

The information acquiring unit may acquire at least one of a distance between a delivery source and the delivery destination of the one or more delivery target articles and a flying time required for the flying object to fly to the location of the delivery destination, and the determination unit may determine whether or not the one or more delivery target articles can be delivered by the flying object on the basis of at least one of the distance between the delivery source and the delivery destination and the flying time.

The information acquiring unit may acquire user type information associated with the user, and the determination unit may control whether or not at least one of determination of whether or not the one or more delivery target articles can be delivered by the flying object and display of the delivery method designation screen on the information terminal by the display control unit is performed, on the basis of whether or not the user type information is a predetermined type.

The determination unit may determine that the one or more delivery target articles can be delivered by the flying object in a case in which it is determined that the one or more delivery target articles can be delivered by at least one of a plurality of flying objects on the basis of flying object information including at least deliverable weights of the plurality of flying objects.

A time specifying unit configured to specify a flying object delivery time that is a time scheduled for delivering the one or more delivery target articles to a delivery destination using the flying object and an alternate delivery time that is a time scheduled to deliver the one or more delivery target articles to the delivery destination using another moving body other than the flying objects may be further included, and the display control unit may cause the information terminal to display the delivery method designation screen under a condition of the flying object delivery time being earlier than the alternate delivery time.

A delivery time calculating unit configured to calculate a delivery time required for each of a plurality of the flying objects to deliver the one or more delivery target articles on the basis of a current time and the flying object delivery time may be further included, and the display control unit may cause the information terminal to display the delivery method designation screen representing a plurality of delivery methods of which delivery times are different from each other in a case in which a plurality of delivery times corresponding to the plurality of the flying objects are different from each other.

Each of a plurality of the articles and information representing availability of delivery using the flying object may be associated with each other in the article database, and the determination unit may determine whether or not one or more delivery target articles, of which the information representing availability of delivery indicates that delivery can be performed, among a plurality of the delivery target articles can be delivered by the flying object.

Each of the plurality of articles and the information representing availability of delivery using the flying object may be associated with each other in the article database, and the determination unit may determine that the one or more delivery target articles cannot be delivered in a case in which the information representing availability of delivery indicates that at least one of the one or more delivery target articles cannot be delivered.

According to a second aspect of the present invention, there is provided an information processing method including: acquiring article identification information used for identifying delivery target articles from an information terminal used by a user requesting delivery of a delivery target article that is a target to be delivered; specifying a total weight value of one or more delivery target articles corresponding to one or more pieces of the article identification information by referring to an article database including weight of each of a plurality of articles; determining whether or not the one or more delivery target articles can be delivered by a flying object on the basis of at least the total weight value; and causing the information terminal to display a delivery method designation screen on which a delivery method for delivering articles using the flying object can be designated in a case in which it is determined that the one or more delivery target articles can be delivered by the flying object.

According to a third aspect of the present invention, there is provided an information processing system including: an information processing device configured to determine whether or not one or more delivery target articles that are targets to be delivered can be delivered by a flying object; and an information terminal configured to display information received from the information processing device, in which the information processing device includes: an information acquiring unit configured to acquire article identification information used for identifying delivery target articles from the information terminal used by a user requesting delivery of a delivery target article; a specifying unit configured to specify the total weight value of the one or more delivery target articles corresponding to one or more pieces of the article identification information acquired by the information acquiring unit by referring to an article database including weight of each of a plurality of articles; a determination unit configured to determine whether or not the one or more delivery target articles can be delivered by a flying object on the basis of at least the total weight value; and a display control unit configured to cause the information terminal to display a delivery method designation screen on which a delivery method for delivering articles using the flying object can be designated in a case in which the determination unit determines that the one or more delivery target articles can be delivered by the flying object, and the information terminal includes an information transmitting unit configured to transmit one or more pieces of the article identification information to the information processing device and a display unit configured to display the delivery method designation screen.

According to the present invention, there is an advantage of being able to easily check whether or not an article to be delivered can be delivered using an unmanned flying object.

### BRIEF DESCRIPTION OF THE DRAWINGS

FIG. 1 is a diagram illustrating the configuration of an information processing system S.

FIGS. 2A to 2C illustrate examples of screens displayed by an information terminal 1.

FIG. 3 is a diagram illustrating the configuration of the information terminal 1.

FIG. 4 is a diagram illustrating the configuration of an information processing device 2.

FIG. 5 is a diagram illustrating an example of an article database stored by a storage unit 22.

FIG. 6 is a flowchart illustrating an example of an operation of the information processing device 2.

### DETAILED DESCRIPTION OF EMBODIMENTS

### [Overview of Information Processing System S]

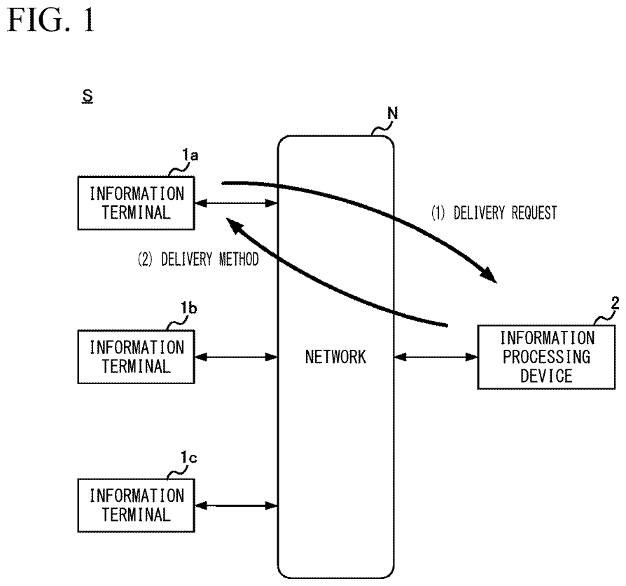

FIG. 1 is a diagram illustrating the configuration of an information processing system S. The information processing system S is a system that is used for enabling a user using an information terminal 1 to request delivery of an article desired to be delivered to a delivery destination (hereinafter, referred to as a “delivery target article”). The information processing system S includes a plurality of information terminals 1 (1a to 1c) and an information processing device 2. The information terminal 1 is, for example, a computer or a smartphone and displays information received from the information processing device 2. For example, the information processing device 2 is a computer. The information processing device 2 may be a single information processing device and, for example, may be composed of a plurality of information processing devices such as a cloud server.

As illustrated in FIG. 1, the information terminals 1 and the information processing device 2 can transmit/receive data via a network N. For example, the network N is the Internet. The network N may include a radio network.

A user can designate a method of delivering a delivery target article. The information processing system S determines whether or not a delivery target article that is a target to be delivered can be delivered by a flying object and allows a user requesting delivery to designate a delivery method for delivering the delivery target article using a flying object in a case in which it is determined that the article can be delivered. The flying object is, for example, a drone, and may be a flying object of a different type as long as it is a flying object that can deliver a delivery target article.

For example, in a case in which a user purchases an article at a shopping site by operating the information terminal 1, the information terminal 1 displays a screen used for requesting delivery of the purchased article. In accordance with reception of a user's operation on the screen, the information terminal 1 transmits a delivery request to the information processing device 2 ((1) in FIG. 1). In the delivery request, article identification information (hereinafter, referred to as an “article ID”) used for identifying the purchased article is included.

When a delivery request is received, the information processing device 2 determines whether or not one ore more delivery target articles can be delivered by a flying object. In a case in which it is determined that an article represented by the article ID received from the information terminal 1 can be delivered by a flying object, the information processing device 2 transmits information representing a delivery method for delivering the article using the flying object to the information terminal 1 ((2) in FIG. 1).

By referring to an article database in which each article ID, the weight of an article represented by the article ID, and the size of the corresponding article are associated with each other, the information processing device 2 determines whether or not the article represented by the article ID received from the information terminal 1 can be delivered by a flying object. For example, by referring to the article database in which data relating to articles is registered, the information processing device 2 specifies a weight of an article associated with an article ID received from the information terminal 1 and determines whether or not the article of the specified weight can be delivered by a flying object.

In a case in which information representing delivery methods that can be used for delivery is received from the information processing device 2, the information terminal 1 displays a delivery method designation screen on which any one of one or more delivery methods represented by the received information can be designated. For example, one or more delivery methods displayed by the information terminal 1 include a delivery method using a flying object and a delivery method using a moving body other than a flying object. For example, a moving body other than a flying object is a vehicle or a ship.

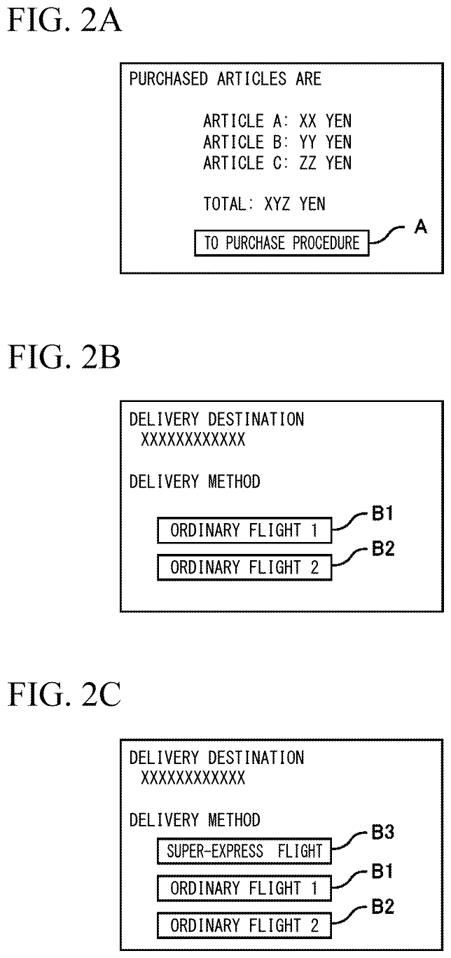

FIGS. 2A to 2C illustrate examples of screens displayed by the information terminal 1. FIGS. 2A is a screen used for a user of the information terminal 1 to start a purchase procedure after selecting an article to be purchased at a shopping site. FIGS. 2B and 2C are screens used for a user to designate a delivery method after a purchase procedure is started. FIG. 2B is a delivery method designation screen displayed by the information terminal 1 in a case in which an article purchased by a user cannot be delivered by a flying object. FIG. 2C is a delivery method designation screen displayed by the information terminal 1 in a case in which an article purchased by a user can be delivered by a flying object.

As illustrated in FIG. 2A, the information terminal 1 displays Article A, Article B, and Article C that are article names of a plurality of articles selected by a user for purchase, prices of the plurality of articles, and a total price of the plurality of articles. For example, in accordance with a user of the information terminal 1 pressing an operation image A representing “to purchase procedure”, the information terminal 1 transmits a plurality of article IDs corresponding to a plurality of articles to the information processing device 2.

In a case in which the information processing device 2 determines that the plurality of articles (Article A, Article B, and Article C) cannot be delivered by a flying object, the information terminal 1, as illustrated in FIG. 2B, displays an operation image B1 representing “Ordinary shipping 1” and an operation image B2 representing “Ordinary shipping 2” that are delivery methods for delivery using a moving body other than a flying object. On the other hand, in a case in which the information processing device 2 determines that the plurality of articles can be delivered by a flying object, the information terminal 1, as illustrated in FIG. 2C, displays an operation image B3, an operation image B1, and an operation image B2 representing “Express shipping” that is a delivery method for delivery using a flying object. The operation image B3 displayed by the information terminal 1, for example, may be an operation image that clearly specifies a delivery method such as “drone delivery”.

In accordance with the information terminal 1 and the information processing device 2 operating as described above, in a case in which a delivery target article can be delivered by a flying object, the information terminal 1 displays a delivery method designation screen on which a delivery method for delivering the delivery target article using a flying object can be designated. On the other hand, in a case in which the delivery target article cannot be delivered by a flying object, the information terminal 1 displays a delivery method designation screen on which a delivery method for delivering the delivery target article using a flying object cannot be selected. As a result, a user requesting delivery of an article can select a delivery method using a flying object only in a case in which the delivery target article can be delivered by a flying object.

### [Configuration of Information Terminal 1]

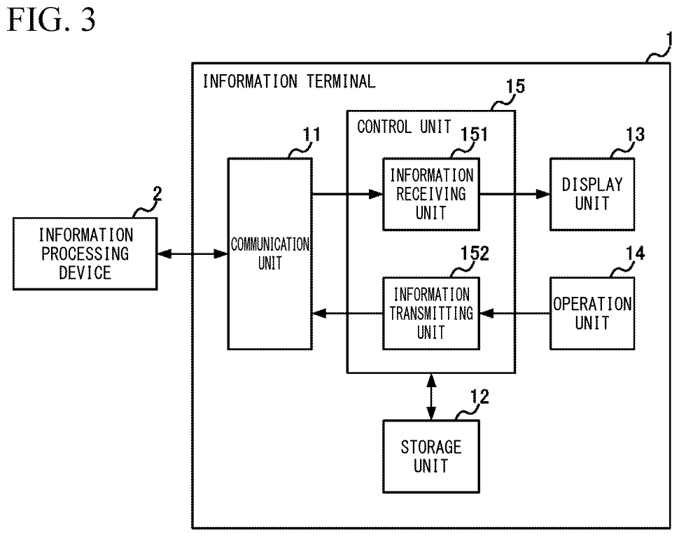

FIG. 3 is a diagram illustrating the configuration of the information terminal 1. The information terminal 1 includes a communication unit 11, a storage unit 12, a display unit 13, an operation unit 14, and a control unit 15. The control unit 15 includes an information receiving unit 151 and an information transmitting unit 152.

The communication unit 11 includes a communication device that is used for receiving information via a network N. For example, the communication device is a local area network (LAN) controller or a wireless LAN controller. The storage unit 12 has a storage media such as a read only memory (ROM), a random access memory (RAM), and a solid state drive (SSD). The storage unit 12 stores a program that is executed by the control unit 15.

The display unit 13, for example, includes a display device such a liquid crystal display, an organic electroluminescent (EL) display, or the like. The display unit 13 displays a delivery method designation screen on the basis of information representing a method for delivering a delivery target article received by the information receiving unit 151 from the information processing device 2. For example, the display unit 13 displays the delivery method designation screen illustrated in FIG. 2B or FIG. 2C. The operation unit 14 is, for example, a touch panel, and accepts an input operation from a user of the information terminal 1.

For example, the control unit 15 is a central processing unit (CPU). By executing a program stored in the storage unit 12, the control unit 15 functions as the information receiving unit 151 and the information transmitting unit 152. The information receiving unit 151 causes the display unit 13 to display the delivery method designation screen on the basis of information representing a delivery method received from the information processing device 2 through the communication unit 11. For example, when information representing a delivery method for delivery using a flying object is received, the information receiving unit 151 causes the display unit 13 to display the delivery method designation screen illustrated in FIG. 2C.

The information transmitting unit 152 transmits one or more article IDs to the information processing device 2 on the basis of an input operation of a user of the information terminal 1 accepted by the operation unit 14. For example, in a case in which the display unit 13 displays a screen for starting a purchase procedure illustrated in FIG. 2A, the information transmitting unit 152 transmits article IDs corresponding to the plurality of articles displayed in FIG. 2A on the basis of a reception of user's pressing of the operation image A by the operation unit 14.

### [Configuration of Information Processing Device 2]

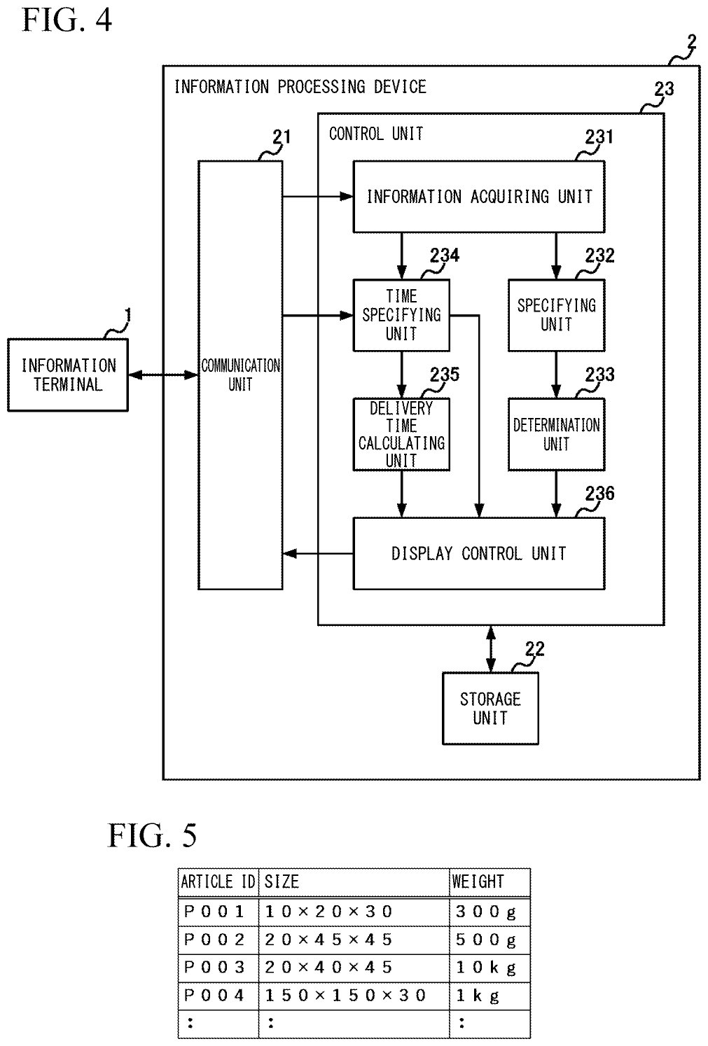

FIG. 4 is a diagram illustrating the configuration of the information processing device 2. The information processing device 2 includes a communication unit 21, a storage unit 22, and a control unit 23. The control unit 23 includes an information acquiring unit 231, a specifying unit 232, a determination unit 233, a time specifying unit 234, a delivery time calculating unit 235, and a display control unit 236.

The communication unit 21 includes a communication device that is used for receiving information via a network N. For example, the communication device is a LAN controller or a wireless LAN controller. The storage unit 22 has a storage media such as a ROM, a RAM, and an SSD. The storage unit 22 stores a program that is executed by the control unit 23. The storage unit 22 stores an article database used for specifying a weight of each of one or more articles represented by one or more article IDs received from the information terminal 1.

FIG. 5 is a diagram illustrating an example of the article database stored by the storage unit 22. In the article database illustrated in FIG. 5, an article ID, a size of an article, and a weight of the article are associated with each other. The size represents a vertical width, a horizontal width, and a height of an article in order of “(vertical width)×(horizontal width)×(height)”, and the unit thereof is centimeters. As illustrated in FIG. 5, the size and the weight of each of a plurality of articles may be associated with each other in the article database.

In addition, each of a plurality of articles and information representing availability of delivery using a flying object may be associated with each other in the article database. For example, availability of delivery using a flying object is determined on the basis of a kind of article. More specifically, in a case in which the type of article is a large household electrical appliance such as a refrigerator or an electric washer, an article ID representing the article is associated with information representing that delivery cannot be performed using a flying object.

For example, the availability of delivery may be determined on the basis of at least one of a weight and a size of each of a plurality of articles. For example, in a case in which a maximum weight that can be delivered by a flying object is 5 kg, an article represented by an article ID “P003” illustrated in FIG. 5 exceeds the maximum weight that can be delivered by a flying object, and thus the article ID and information representing that delivery cannot be performed by a flying object are associated with each other.

An article ID representing an article that cannot be delivered by a flying object may not be associated with information representing a weight or a size of the article in the article database. For example, in the article database illustrated in FIG. 5, in a case in which a flying object can deliver an article represented by an article ID “P001”, the weight and the size of the article represented by the article ID “P001” are associated with the article ID “P001” in the article database. On the other hand, in a case in which a flying object cannot deliver an article represented by an article ID “P003”, the weight and the size of the article represented by the article ID “P003” are not associated with the article ID “P003” in the article database.

The control unit 23 is, for example, a CPU. By executing a program stored in the storage unit 22, the control unit 23 functions as the information acquiring unit 231, the specifying unit 232, the determination unit 233, the time specifying unit 234, the delivery time calculating unit 235, and the display control unit 236.

The information acquiring unit 231 acquires various kinds of information used for determining a delivery method from the information terminal 1 or an external device. The information acquiring unit 231, for example, acquires information representing a delivery method selected by a user and an article ID used for identifying a delivery target article from the information terminal 1 used by the user requesting delivery of the delivery target article that is a target to be delivered, through the communication unit 21. The information acquiring unit 231 may further acquire delivery destination information including location information that represents a location of a delivery destination of the delivery target article.

The information acquiring unit 231 may further acquire use status information that represents a use status of each of a plurality of flying objects. For example, the use status information is information that represents a state of whether a flying object is “during delivery” or “during standby”. Return date and time information representing a scheduled date and time at which a flying object will return to a predetermined place may be included in the use status information. For example, the information acquiring unit 231 acquires use status information from an external device that manages statuses of a plurality of flying objects. The information processing device 2 may include a processing unit that manages statuses of flying objects, and the information acquiring unit 231 may acquire the use status information from the processing unit.

The information acquiring unit 231 may acquire at least one of a distance between a delivery source and a delivery destination of a delivery target article and a flying time required for a flying object to fly to the location of the delivery destination.

For example, the information acquiring unit 231 acquires such information from a database in which the distance between a delivery source and a delivery destination or a flying time from the delivery source to the delivery destination is registered.

The specifying unit 232 specifies a weight of the delivery target article. By referring to an article database including a weight of each of a plurality of articles, the specifying unit 232 specifies a total weight value of one or more delivery target articles corresponding to one or more article IDs acquired by the information acquiring unit 231. For example, in a case in which the information acquiring unit 231 acquires article IDs “P001” and “P002” illustrated in FIG. 5, the specifying unit 232 specifies the total weight value as being “800 g” on the basis of a weight “300 g” associated with the article ID “P001” and a weight “500 g” associated with the article ID “P002”.

The specifying unit 232 may specify a total size value of one or more delivery target articles. For example, in a case in which the information acquiring unit 231 acquires article IDs “P002” and “P003” illustrated in FIG. 5, the specifying unit 232 specifies a total size value on the basis of a size “20×45×45” associated with the article ID “P002” and a size “20×40×45” associated with the article ID “P003”. For example, the specifying unit 232 specifies “40×45×45” or “20×85×45” that is the total size value acquired in a case in which articles represented by the article IDs “P002” and “P003” are horizontally aligned or “20×45×90” that is the total size value acquired in a case in which the articles are vertically piled.

The determination unit 233 determines whether or not the plurality of delivery target articles can be delivered by a flying object on the basis of at least the total weight value. For example, by referring to flying object information representing a deliverable weight of each flying object delivering an article, in a case in which the total weight value specified by the specifying unit 232 is equal to or smaller than the deliverable weight of the flying object, the determination unit 233 determines that the flying object can deliver the plurality of delivery target articles. For example, the flying object information is stored in the storage unit 22. For example, in a case in which the deliverable weight of the flying object is 5 kg, and the total weight value of a plurality of delivery target articles specified by the specifying unit 232 is 800 g, the determination unit 233 determines that the plurality of delivery target articles can be delivered.

The determination unit 233 may determine whether or not the flying object can deliver the delivery target articles on the basis of the total size value. For example, by referring to flying object information representing a deliverable size of each flying object delivering articles, in a case in which a total size value specified by the specifying unit 232 is equal to or smaller than the deliverable size of the flying object, the determination unit 233 may determine that the flying object can deliver the plurality of delivery target articles.

The determination unit 233 may determine whether or not the flying object can deliver the delivery target articles on the basis of the total weight value and the total size value. For example, in a case in which the total weight value specified by the specifying unit 232 is equal to or smaller than the deliverable weight of the flying object and in a case in which the total size value specified by the specifying unit 232 is equal to or smaller than the deliverable size of the flying object, the determination unit 233 determines that the flying object can deliver the plurality of delivery target articles. By causing the determination unit 233 to operate in this way, the determination unit 233 can determine whether or not delivery target articles can be delivered by a flying object with high accuracy.

The determination unit 233 may determine whether or not delivery target articles can be delivered by a flying object on the basis of use statuses of a plurality of flying objects represented by use status information. For example, the determination unit 233 determines that flying delivery target articles can be delivered by a flying object in a case in which there are at least one or more flying object of which use status information acquired by the information acquiring unit 231 represents “during standby” and determines that delivery target articles cannot be delivered by a flying object in a case in which use status information of all the flying objects represents “during delivery”.

In a case in which return date and time information is included in use status information acquired by the information acquiring unit 231, the determination unit 233 may determine that delivery target articles can be delivered by a flying object on the basis of a date and time represented by the return date and time information. For example, even in a case in which the use status information of all the flying objects represents “during delivery”, when there is a flying object of which the return date and time information is in a range of a predetermined time from the current time, the determination unit 233 determines that delivery target articles can be delivered by a flying object. Here, the predetermined time is, for example, a time for packing delivery target articles and is a time for preparing target delivery articles to be in a deliverable state. By causing the determination unit 233 to operate in this way, even when a flying object is during delivery, the determination unit 233 can determine that the flying object can be used. As a result, the number of flying objects that can be used for delivery increases, and thus the likelihood of a user being able to designate a delivery method using a flying object on the delivery method designation screen can be raised.

The determination unit 233 may determine whether or not delivery target articles can be delivered by a flying object on the basis of a location of a delivery destination represented by delivery destination information acquired by the information acquiring unit 231. For example, the determination unit 233 determines whether or not delivery target articles can be delivered by a flying object on the basis of whether the location of a delivery destination is included in an area to which the flying object can deliver delivery target articles. In a case in which the location of a delivery destination represented by the delivery destination information is included in an area to which the flying object can deliver delivery target articles, the determination unit 233 determines that the delivery target articles can be delivered by the flying object. On the other hand, in a case in which the location of a delivery destination is not included in an area to which the flying object can deliver delivery target articles or in a case in which the location of a delivery destination is included in an area to which the flying object cannot deliver delivery target articles, the determination unit 233 determines that the delivery target articles cannot be delivered by the flying object.

Information representing areas to which delivery target articles cannot be delivered is stored in the storage unit 22 in advance. For example, an area to which delivery target articles cannot be delivered is an area in which it is difficult for the flying object to fly due to many obstacles or an area in which it is difficult to secure a landing place.

The determination unit 233 may determine whether or not delivery target articles can be delivered by a flying object on the basis of at least one of a distance between a delivery source and a delivery destination and a flying time. For example, in a case in which a distance between a delivery source and a delivery destination acquired by the information acquiring unit 231 is equal to or shorter than a predetermined distance, the determination unit 233 determines that delivery target articles can be delivered by a flying object. Here, for example, the predetermined distance is a distance over which a round trip can be made using a remaining amount of a battery of a flying object. By causing the determination unit 233 to operate in this way, it can be prevented from a delivery method designation screen on which a delivery method using a flying object can be designated being displayed in the information terminal 1 although the distance to the delivery destination is the distance over which a flying object cannot fly.

In a case in which a flying time required for a flying object to fly from a delivery source to a delivery destination is equal to or shorter than a predetermined time, the determination unit 233 may determine that delivery target articles can be delivered by the flying object. Here, for example, the predetermined time is a time in which a moving body such as a truck other than a flying object moves. By causing the determination unit 233 to operate in this way, a delivery method designation screen on which a delivery method using the flying object can be designated can be prevented from being displayed in the information terminal 1 although delivery of delivery target articles using a moving body other than the flying object can be performed in a shorter time.

In a case in which it is determined that delivery target articles can be delivered by at least one of a plurality of flying objects on the basis of flying object information including at least a deliverable weight of each of a plurality of flying objects, the determination unit 233 may determine that the delivery target articles can be delivered by a flying object. For example, the determination unit 233 compares the deliverable weight of each of a plurality of flying objects represented by flying object information acquired from the storage unit 12 with a total weight value of delivery target articles. Subsequently, in a case in which a deliverable weight of one or more flying objects is equal to or larger than the total weight value of delivery target articles, the determination unit 233 determines that the delivery target articles can be delivered by a flying object.

The determination unit 233 may determine whether or not one or more delivery target articles, of which information representing availability of delivery represents being deliverable, among a plurality of delivery target articles can be delivered by a flying object. By referring to the article database, the determination unit 233 specifies information representing availability of delivery associated with an article ID of each of a plurality of delivery target articles. Subsequently, the determination unit 233 determines whether or not delivery target articles can be delivered by a flying object only for the delivery target articles represented by article IDs associated with the information, which represents availability of delivery, indicating being deliverable.

By causing the determination unit 233 to operate in this way, the determination unit 233 can determine whether or not delivery target articles can be delivered by a flying object only for articles that can be delivered by a flying object. For example, the determination unit 233 does not determine availability of delivery on the basis of the weight, the size, or the like of delivery target articles such as a refrigerator and the like that are registered in the article database as being unable to be delivered by a flying object in advance and thus can shorten the time required for a determination process.

In a case in which the information representing availability of delivery indicates that at least one of a plurality of delivery target articles designated in the information terminal 1 cannot be delivered, the determination unit 233 may determine that the plurality of delivery target articles cannot be delivered. For example, in a case in which one or more pieces of information among pieces of information representing availability of delivery associated with articles IDs of a plurality of delivery target articles indicates that delivery cannot be performed, the determination unit 233 determines that the plurality of all the delivery target articles cannot be delivered by a flying object. By causing the determination unit 233 to operate in this way, in a case in which it is determined that one article cannot be delivered, availability of delivery of the other articles does not need to be determined, and thus a time required for a determination process can be shortened.

The determination unit 233 may determine whether or not a delivery target article of which delivery has been requested by a certain user is to be delivered together with a delivery target article of which delivery has been requested by another user. More specifically, the determination unit 233 may determine a delivery method for delivery target articles of which delivery has been requested by a user of the information terminal 1 that has transmitted article IDs on the basis of delivery information acquired from another information terminal 1 other than the information terminal 1 that has transmitted the article IDs to the information acquiring unit 231.

For example, the determination unit 233 determines whether or not a first delivery target article of which delivery has been requested by the user of the information terminal 1a is to be delivered together with a second delivery target article of which delivery has been requested by a user of the information terminal 1b on the basis of the delivery information of the information terminal 1b acquired by the information acquiring unit 231. For example, in a case in which a delivery charge can be lowered by delivering the first delivery target article together with the second delivery target article, the determination unit 233 determines that the first delivery target article is delivered together with the second delivery target article.

For example, in a case in which a delivery destination represented by delivery information of the information terminal 1b and a delivery destination represented by delivery information of the information terminal 1a are within a predetermined range, and delivery using a flying object is designated on the delivery method designation screen represented by the delivery information of the information terminal 1b, the determination unit 233 may determine that the delivery target article of the user of the information terminal 1a is delivered together with the delivery target article of the user of the information terminal 1b. Here, the predetermined range is a range in which moving on foot can be easily performed and, for example, is within a site at which a plurality of apartment houses are built.

Meanwhile a delivery charge for delivery using a flying object is higher than a delivery charge for delivery using another moving body other than the flying object. For this reason, in a case in which a date and time at which another moving body other than the flying object arrives at a delivery destination is earlier than a date and time at which the flying object arrives at the delivery destination, a delivery destination user selects delivery using the other moving body other than the flying object in many cases. Thus, in order to cause the information terminal 1 to display a delivery method designation screen on which the flying object can be selected under a condition of a delivery time using the flying object being earlier than that using the other moving body other than the flying object, the information processing device 2 includes the time specifying unit 234 that is used for specifying a delivery time of the flying object and a delivery time of another moving body other than the flying object.

The time specifying unit 234 specifies a flying object delivery time that is a time at which delivery target articles are scheduled to be delivered to a delivery destination using the flying object and an alternate delivery time that is a time at which the delivery target articles are scheduled to be delivered to the delivery destination using another moving body other than the flying object. For example, the time specifying unit 234 specifies a flying object delivery time on the basis of a flight start time of the flying object included in the use status information acquired by the information acquiring unit 231 and a flying time of the flying object acquired by the information acquiring unit 231. For example, the time specifying unit 234 specifies an alternative delivery time on the basis of a movement start time of the other moving body other than the flying object and a movement time of the moving body acquired by the information acquiring unit 231. The time specifying unit 234 outputs the flying object delivery time and the alternate delivery time to the display control unit 236.

In a case in which a plurality of flying objects can perform delivery earlier than another moving body other than a flying object, a delivery destination user desires to select a delivery method by referring to a plurality of times at which delivery target articles are scheduled to be delivered to the delivery destination. Thus, the information processing device 2 includes the time specifying unit 234 that is used for calculating delivery times of a plurality of flying objects.

The delivery time calculating unit 235 calculates delivery times required for a plurality of flying objects to deliver delivery target articles on the basis of the current time and flying object delivery times. For example, the delivery time calculating unit 235 calculates delivery times of a plurality of flying objects that are differences between the flying object delivery times of the plurality of flying objects specified by the time specifying unit 234 and the current time. For example, in a case in which the current time is “15:00”, and flying object delivery times according to delivery performed by flying object flying at 15:00 or later are “17:00” and “18:00”, the delivery time calculating unit 235 calculates delivery times “2 hours” and “3 hours”. The delivery time calculating unit 235 may calculate delivery times on the basis of flight start times of the plurality of flying objects included in the use status information acquired by the information acquiring unit 231 and flying times of the plurality of flying objects acquired by the information acquiring unit 231.

The display control unit 236 causes the information terminal 1 to display the delivery method designation screen as illustrated in FIG. 2. In a case in which the determination unit 233 determines that delivery target articles can be delivered by a flying object, the display control unit 236 causes the information terminal 1 to display a delivery method designation screen on which a delivery method for delivering articles using the flying object can be designated. For example, the display control unit 236 causes the information terminal 1 to display the delivery method designation screen as illustrated in FIG. 2C in a case in which the determination unit 233 determines that delivery target articles can be delivered by the flying object and causes the information terminal 1 to display the delivery method designation screen as illustrated in FIG. 2B in a case in which the determination unit 233 determines that delivery target articles cannot be delivered by the flying object. A screen displaying a delivery method using the flying object may be a screen on which a delivery method for delivering articles using the flying object is displayed in a popup screen on the screen illustrated in FIG. 2B.

The display control unit 236 may cause the information terminal 1 to display a delivery method designation screen including a delivery method using a flying object under the condition of the flying object delivery time being earlier than an alternate delivery time that is a time scheduled to deliver delivery target articles to a delivery destination using another moving body other than the flying object. The display control unit 236 may cause the information terminal 1 to display a delivery method designation screen including a delivery method using the flying object only in a case in which the flying object delivery time specified by the time specifying unit 234 is earlier than the alternative delivery time specified by the time specifying unit 234. A delivery charge for delivery using the flying object is higher than a delivery charge for delivery using another moving body other than the flying object. Thus, the display control unit 236 may cause the information terminal 1 to display a delivery method using the flying object only in a case in which delivery using the flying object of which the delivery charge is high is faster than delivery using another moving body other than the flying object. By causing the display control unit 236 to operate in this way, the information terminal 1 can prevent a user from designating the flying object of which a delivery charge is high in spite of the delivery time using the flying object being longer than that using another moving body.

In a case in which delivery times corresponding to a plurality of flying objects are different from each other, the display control unit 236 may cause the information terminal 1 to display a delivery method designation screen representing a plurality of delivery methods of which the delivery times are different from each other. For example, in a case in which delivery times calculated by the delivery time calculating unit 235 are “10 minutes” and “30 minutes”, the display control unit 236 may cause the information terminal 1 to display a delivery method designation screen representing a delivery method of which the delivery time is “10 minutes” and a delivery method of which the delivery time is “30 minutes”. In each of the plurality of delivery methods represented by the delivery method designation screen, the delivery time may be displayed. By causing the display control unit 236 to operate in this way, a user of the information terminal 1 can designate a desired delivery time from the plurality of delivery times.

The display control unit 236 refers to a database in which information relating to users, which is stored in the storage unit 22, is registered and, in a case in which a user of the information terminal 1 is determined to be a user paying an additional charge other than the delivery charge, may further display a delivery method using a flying object that can be used by paying the additional charge (hereinafter, referred to as “Special shipping”) on the delivery method selection screen. The special shipping is a shipping method that can be used by a user paying additional charge and cannot be used by a user not paying the additional charge and, for example, is a shipping method in which shipping can be performed at a higher speed than a shipping method other than the special shipping, or articles more than those according to a shipping method other than the special shipping can be shipped. The display control unit 236 causes the information terminal 1 used by a user who has paid the additional charge to display a delivery method “Super-express shipping” in addition to “Ordinary shipping” and “Express shipping”, and the user can select a desired delivery method including the special shipping. A service for which such a special shipping can be used is appropriate for a user who needs to deliver articles in a short period of time.

Meanwhile, there are cases in which a user desires to deliver both a first article that can be delivered by a flying object and a second article that cannot be delivered by the flying object to the same delivery destination. In a case in which a user of the information terminal 236 requests delivery of a first article that can be delivered by the flying object and a second article that cannot be delivered by the flying object, the display control unit 236 may cause the information terminal 1 to display a selection screen on which it can be selected whether or not the first article and the second article are delivered by the same moving body. In a case in which the user of the information terminal 1 selects a method for delivering the first article and the second article using the same moving body, the display control unit 236 causes the information terminal 1 to display a delivery method designation screen as illustrated in FIG. 2B on which only delivery methods using moving bodies other than the flying object can be selected.

On the other hand, in a case in which the user of the information terminal 1 selects a method for delivering the first article and the second article using different moving bodies, the display control unit 236, for example, causes the information terminal 1 to display a screen illustrated in FIG. 2C as a delivery method designation screen of the first article and causes the information terminal 1 to display a screen illustrated in FIG. 2B as a delivery method designation screen of the second article. As one example, a charge in a case in which the first article and the second article are delivered using different moving bodies is set to be higher than a charge in a case in which the first article and the second article are delivered using the same moving body. By causing the display control unit 236 to operate in this way, a user of the information terminal 1 can designate an optimal delivery method in accordance with a budget and a degree of urgency of the delivery.

### [Flowchart of Information Processing Device 2]

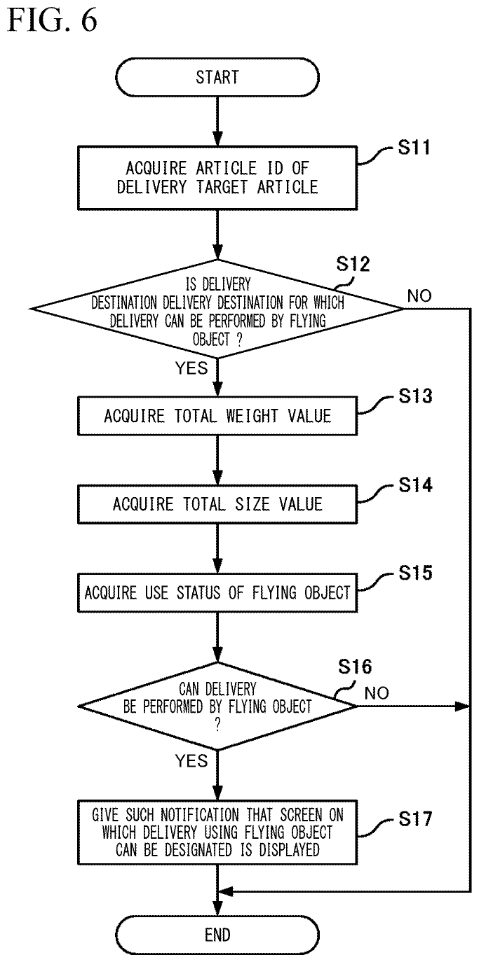

FIG. 6 is a flowchart illustrating an example of an operation of the information processing device 2. The flowchart illustrated in FIG. 6 illustrates operations until the information processing device 2 causes the information terminal 1 to display a delivery method designation screen after the information processing device 2 acquires article IDs from the information terminal 1.

The information acquiring unit 231 acquires article IDs of delivery target articles from the information terminal 1 (S11). In a case in which a location of a delivery destination is a location for which delivery can be performed by a flying object (Yes in S12), the determination unit 233 acquires the total weight value specified by the specifying unit 232 (S13).

The determination unit 233 acquires a total size value specified by the specifying unit 232 (S14). The determination unit 233 acquires use status information that represents use statuses of a plurality of flying objects acquired by the information acquiring unit 231 (S15). The determination unit 233 determines whether or not the delivery target articles can be delivered by a flying object on the basis of the total weight value, the total size value, and the use statuses of flying objects that have been acquired. In a case in which the determination unit 233 determines that delivery can be performed

(Yes in S16), the display control unit 236 notifies the information terminal 1 so as to cause the information terminal 1 to display a delivery method designation screen on which delivery using the flying object can be designated (S17).

In a case in which the location of the delivery destination is a location for which delivery cannot be performed by a flying object (No in S12) or in a case in which it is determined that delivery cannot be performed using the flying object on the basis of the total weight value, the total size value, and the use statuses of flying objects (No in S16), the determination unit 233 ends the process.

### [Modified Example]

In the description presented above, although an operation of the information processing device 2 determining whether or not delivery target articles can be delivered by a flying object on the basis of article IDs acquired from the information terminal 1 has been illustrated, the information processing device 2 may determine whether or not delivery can be performed by the flying object on the basis of information associated with a user of the information terminal 1.

In such a case, the information acquiring unit 231 acquires user type information associated with the user. For example, the user type information is a membership type of a shopping site at which a user has purchased an article. Examples of membership types include a general membership to which subscription can be made by a user registering user information in a shopping site and a premium membership to which subscription can be made by paying a membership fee after registration of user information. For example, there are cases in which a user can subscribe to a premium membership without paying a membership fee by subscribing to a service different from the shopping site. For example, the information acquiring unit 231 acquires the user type information from the information terminal 1 or an information processing device managing the shopping site.

The determination unit 233 controls whether or not at least one of determination of whether or not delivery target articles can be delivered by a flying object and display of a delivery method designation screen in the information terminal 1 using the display control unit 236 is performed on the basis of whether the user type information is a predetermined type. For example, the predetermined type is a type for which delivery of delivery target articles using the flying object can be selected. More specifically, the predetermined type is a premium membership.

For example, in a case in which the user type information acquired by the information acquiring unit 231 represents a membership type for which delivery of delivery target articles using a flying object cannot be selected, the determination unit 233 determines that delivery cannot be performed even when the weight of the delivery target articles is equal to or smaller than the deliverable weight of the flying object. By causing the determination unit 233 to operate in this way, for example, delivery using the flying object can be performed in accordance with a membership type of user registered in a shopping site as a member, and this a user is motivated to perform membership registration.

### [Effects of Information Processing Device 2]

As described above, the information processing device 2 includes the information acquiring unit 231 that acquires article IDs used for identifying delivery target articles from the information terminal 1 used by a user requesting delivery of the delivery target articles that are targets to be delivered and the specifying unit 232 that specifies a total weight value of a plurality of delivery target articles corresponding to the plurality of article IDs acquired by the information acquiring unit 231 by referring to the article database including weights of the plurality of articles.

Then, the determination unit 233 determines whether or not the plurality of delivery target articles can be delivered by a flying object on the basis of at least the total weight value, and, in a case in which the determination unit 233 determines that the delivery target articles can be delivered by the flying object, the display control unit 236 causes the information terminal 1 to display the delivery method designation screen on which a delivery method for delivering the articles using the flying object can be designated, whereby a user of the information terminal 1 can easily notice whether or not articles of which delivery has been requested can be delivered using the flying object.

In addition, the present invention can contribute to Goal 9 “Build resilient infrastructure, promote inclusive and sustainable industrialization, and foster innovation” of sustainable development goals (SDGs) lead by U.N.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, all or a part of each device can be configured to be distributed or integrated functionally or physically in arbitrary units. In addition, a new embodiment formed by arbitrarily combining a plurality of embodiments belongs to an embodiment of the present invention as well. Effects of the new embodiment formed through combination include the effects of the original embodiment.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An information processing device comprising:
an information acquiring unit configured to acquire article identification information used for identifying delivery target articles from an information terminal used by a user requesting delivery of a delivery target article that is a target to be delivered;
a specifying unit configured to specify a total weight value of one or more delivery target articles corresponding to one or more pieces of the article identification information acquired by the information acquiring unit by referring to an article database including weight of each of a plurality of articles;
a determination unit configured to determine whether or not the one or more delivery target articles can be delivered by a flying object on the basis of at least the total weight value; and
a display control unit configured to cause the information terminal to display a delivery method designation screen on which a delivery method for delivering articles using the flying object can be designated in a case in which the determination unit determines that the one or more delivery target articles can be delivered by the flying object.

2. The information processing device according to claim 1,
wherein sizes and the weights of the plurality of articles are associated with each other in the article database,
wherein the specifying unit specifies a total size value of the one or more delivery target articles, and
wherein the determination unit determines whether or not the one or more delivery target articles can be delivered by the flying object on the basis of the total weight value and the total size value.

3. The information processing device according to claim 1,
wherein the information acquiring unit further acquires use status information that represents use statuses of the plurality of flying objects, and
wherein the determination unit determines whether or not the one or more delivery target articles can be delivered by the flying object on the basis of the use status of the flying object represented by the use status information.

4. The information processing device according to claim 3,
wherein return date and time information representing a date and time at which the flying object is scheduled to return to a predetermined place is included in the use status information, and
wherein the determination unit determines whether or not the one or more delivery target articles can be delivered by the flying object on the basis of the date and time represented by the return date and time information.

5. The information processing device according to claim 1,
wherein the information acquiring unit further acquires delivery destination information including location information representing location of delivery destinations of the one or more delivery target articles, and
wherein the determination unit determines whether or not the one or more delivery target articles can be delivered by the flying object on the basis of the location of the delivery destinations represented by the delivery destination information.

6. The information processing device according to claim 5, wherein the determination unit determines whether or not the one or more delivery target articles can be delivered by the flying object on the basis of whether or not the location of the delivery destination is included in an area, to which the one or more delivery target articles can be delivered by the flying object, that is set in advance.

7. The information processing device according to claim 5,
wherein the information acquiring unit acquires at least one of a distance between a delivery source and the delivery destination of the one or more delivery target articles and a flying time required for the flying object to fly to the location of the delivery destination, and
wherein the determination unit determines whether or not the one or more delivery target articles can be delivered by the flying object on the basis of at least one of the distance between the delivery source and the delivery destination and the flying time.

8. The information processing device according to claim 1,
wherein the information acquiring unit acquires user type information associated with the user, and
wherein the determination unit controls whether or not at least one of determination of whether or not the one or more delivery target articles can be delivered by the flying object and display of the delivery method designation screen on the information terminal by the display control unit is performed, on the basis of whether or not the user type information is a predetermined type.

9. The information processing device according to claim 1, wherein the determination unit determines that the one or more delivery target articles can be delivered by the flying object in a case in which it is determined that the one or more delivery target articles can be delivered by at least one of a plurality of flying objects on the basis of flying object information including at least deliverable weights of the plurality of flying objects.

10. The information processing device according to claim 1, further comprising a time specifying unit configured to specify a flying object delivery time that is a time scheduled for delivering the one or more delivery target articles to a delivery destination using the flying object and an alternate delivery time that is a time scheduled to deliver the one or more delivery target articles to the delivery destination using another moving body other than the flying objects,
wherein the display control unit causes the information terminal to display the delivery method designation screen under a condition of the flying object delivery time being earlier than the alternate delivery time.

11. The information processing device according to claim 10, further comprising a delivery time calculating unit configured to calculate a delivery time required for each of a plurality of the flying objects to deliver the one or more delivery target articles on the basis of a current time and the flying object delivery time,
wherein the display control unit causes the information terminal to display the delivery method designation screen representing a plurality of delivery methods of which delivery times are different from each other in a case in which a plurality of delivery times corresponding to the plurality of the flying objects are different from each other.

12. The information processing device according to claim 1,
wherein each of a plurality of the articles and information representing availability of delivery using the flying object are associated with each other in the article database, and
wherein the determination unit determines whether or not one or more delivery target articles, of which the information representing availability of delivery indicates that delivery can be performed, among a plurality of the delivery target articles can be delivered by the flying object.

13. The information processing device according to claim 1,
wherein each of the plurality of articles and the information representing availability of delivery using the flying object are associated with each other in the article database, and
wherein the determination unit determines that the one or more delivery target articles cannot be delivered in a case in which the information representing availability of delivery indicates that at least one of the one or more delivery target articles cannot be delivered.

14. An information processing method comprising:
acquiring article identification information used for identifying delivery target articles from an information terminal used by a user requesting delivery of a delivery target article that is a target to be delivered;
specifying a total weight value of one or more delivery target articles corresponding to one or more pieces of the article identification information by referring to an article database including weight of each of a plurality of articles;
determining whether or not the one or more delivery target articles can be delivered by a flying object on the basis of at least the total weight value; and
causing the information terminal to display a delivery method designation screen on which a delivery method for delivering articles using the flying object can be designated in a case in which it is determined that the one or more delivery target articles can be delivered by the flying object.

15. An information processing system comprising:
an information processing device configured to determine whether or not one or more delivery target articles that are targets to be delivered can be delivered by a flying object; and
an information terminal configured to display information received from the information processing device,
wherein the information processing device includes:
an information acquiring unit configured to acquire article identification information used for identifying delivery target articles from the information terminal used by a user requesting delivery of a delivery target article;
a specifying unit configured to specify a total weight value of the one or more delivery target articles corresponding to one or more pieces of the article identification information acquired by the information acquiring unit by referring to an article database including weight of each of a plurality of articles;
a determination unit configured to determine whether or not the one or more delivery target articles can be delivered by a flying object on the basis of at least the total weight value; and
a display control unit configured to cause the information terminal to display a delivery method designation screen on which a delivery method for delivering articles using the flying object can be designated in a case in which the determination unit determines that the one or more delivery target articles can be delivered by the flying object, and
wherein the information terminal includes an information transmitting unit configured to transmit one or more pieces of the article identification information to the information processing device and a display unit configured to display the delivery method designation screen.
